(19) United States
(12) Patent Application Publication
(10) Pub. No.: US 2024/0083796 A1
(43) Pub. Date: Mar. 14, 2024

(54) HOSE MANAGEMENT ASSEMBLY FOR WATER MINERALIZATION SYSTEM

(71) Applicant: CORE PACIFIC INC., Houston, TX (US)

(72) Inventor: Patrick GWEN, Houston, TX (US)

(21) Appl. No.: 18/480,994

(22) Filed: Oct. 4, 2023

Related U.S. Application Data
(63) Continuation-in-part of application No. 18/175,998, filed on Feb. 28, 2023.
Application No. 18/175,998 is a continuation of application No. 17/815,479, filed on Jul. 27, 2022, now Pat. No. 11,597,669.

(51) Int. Cl. C02F 9/00

(52) U.S. Cl. CPC C02F 9/00; C02F 1/003

(57) ABSTRACT

A hose management assembly for a water mineralization system has a housing with a filter positioned therein, a container receptacle assembly affixed to or formed on the housing, a pump cooperative with the container receptacle assembly so as to pass a mineral or supplement from a bottle, a first block affixed to a wall of the housing, and a second block affixed to the wall of the housing and spaced relation to the first block. The filter has a first hose extending therefrom. The inlet of the housing allows tap water to pass to the housing by a second hose. Drinking water is passed from the housing through the first hose. The first block receives a portion of the first and second hoses therein. The second block receives another portion of the first and second hoses therein.

### CROSS-REFERENCE TO RELATED APPLICATIONS

The present application is a continuation-in-part of U.S. patent application Ser. No. 18/175,998, filed on Feb. 28, 2023, presently pending. U.S. application Ser. No. 18/175,998 is a continuation of U.S. patent application Ser. No. 17/815,479, filed on Jul. 27, 2022, which issued as U.S. Pat. No. 11,597,669 on Mar. 7, 2023.

### FIELD OF THE INVENTION

The present invention relates to a water filter assembly. More particularly, the present invention relates to water filter assemblies wherein minerals are added to filtered water. More particularly, the present invention relates to the management of hoses extending to and from the water filter assembly so as to avoid tangling, kinking, and the effects of yanking.

### BACKGROUND OF THE INVENTION

In the art of water treatment, it is well-known to purify water for human consumption by implementing specific purifying processes. These purifying processes included, for example, the processes of filtration, sediment, bacterial digestion, distillation or reverse osmosis. In reverse osmosis, for example, a volume of liquid containing contaminants is introduced into a chamber on one side of a semi-permeable membrane (i.e. having pores large enough to pass the molecules of the liquid but not those of the solute contaminant). By pressurizing the liquid above its osmotic pressure, the liquid molecules will diffuse across the membrane but the solute molecules will remain. The resulting brine is then discarded and the liquid is thus purified and retained.

Such reverse osmosis systems can be configured to produce purified water from virtually any source and remove many of the contaminants contained therein, including dissolved mineral ions, with great effectiveness. While this is advantageous for many reasons and in many applications, it is nonetheless imperfect for the production of drinking water. Specifically, in the case of a reverse-osmosis process, it is not selective. In other words, it removes all dissolved mineral ions, both those which are desirable for health and taste along with those which are not. In the end, the produced water is a demineralized water free of any mineral ions.

It is therefore known to pass the demineralized water through a subsequent step for replenishing certain minerals lost and adding other desirable minerals not present in the water prior to the start of the purification process. In particular, calcium, magnesium and bicarbonate are particularly desirable. Their presence in drinking water may contribute to establishing and maintaining physical and mental health. These ions are also partly responsible for creating a pleasant taste in the drinking water.

One such means of doing this is to dissolve a mixture of mineral salts into the water. Commonly employed additives include calcium chloride, magnesium sulphate, chloride, bicarbonate of sodium, or potassium. However, the use of such salts will result in the presence of unwanted chloride, sulfate, sodium and potassium ions which can negatively affect the taste of water and bring a bitter and/or salty taste in the final product. At certain quantities, these can have deleterious effects on the health of certain sensitive customers (i.e. for people having specific diets, for example).

In the past, the minerals that are to be introduced into the filtered water are provided in a pellet form. Typically, the minerals are encapsulated in clay which slowly dissolves as the minerals are dissolved into the water. Unfortunately, the quality control of such mineral-bearing clay pellets is often inconsistent and quality control is minimal. As a result, the quality of the minerals, the quantity of the minerals, and the rate of mineral diffusion in the drinking water can be relatively uncontrolled. Under certain circumstances, the initial water washing across the mineral-bearing clay pellets will have a large amount of minerals therein. Later passages of water across the mineral-bearing clay pellets will have a lower mineral content. As such, the exact dosing of minerals into the drinking water is unavailable in the prior art.

It is the goal of the remineralization process to re-mineralize demineralized water with ions and minerals so as to establish and maintain physical and mental health while avoiding the undesirable ones for taste or health issues. It is therefore desirable to provide a means for re-mineralizing demineralized water with desirable ions, without also adding undesirable amounts, counter-ions and/or compounds.

U.S. Pat. No. 11,597,669, issuing to the present Applicant, describes an apparatus for mineralizing in drinking water. In this apparatus, there is one hose for passing the filtered water outwardly of the housing, another hose for passing tap water into the housing, and an further hose for passing the brine from the reverse osmosis filter outwardly of the housing. As such, a need developed so as to be able to manage these three hoses. Management is important to avoid kinking, tangling, and the effects of yanking. The water mineralization system of this patent is generally intended to be installed in a remote location, such as under a sink or within cabinets beneath the sink. One of the hoses is intended to be connected to the tap water inlet of the sink. Another hose is connected so as to be dispensed by a faucet on top of the cabinet or at the sink. A third hose can be connected to the drain so as to allow the brine from the reverse osmosis filter to pass to the drain and to the sewage system. During normal use, it was found that during the installation of this water mineralization system, there is a tendency to yank on these various hoses so as to cause the hose to be moved to a desirable position. Unfortunately, the yanking of these hoses could cause a disconnection of the hose with the components on the interior of the housing or to otherwise interfere with the proper operation of the water mineralization system. In other circumstances, in cramped environments, there is a tendency for an installer to bend the hoses in a an extreme manner so as to ultimately kink the hose and prevent the proper flow of water or brine through the hoses. Still, in other circumstances, the hoses would become tangled so that it was difficult for the installer to decide which hose was intended to be connected to a faucet, which hose was intended to be connected to the water inlet in which hose was intended to be connected to the drain. As such, a need developed so as to provide a hose management system for the water mineralization system of the present invention.

In the past various patents and publications have issued with respect to the mineralization of drinking water. For example, U.S. Patent Application Publication No. 2018/0370826, published on Dec. 27, 2018 to Sublet et al., teaches a method and apparatus for providing re-mineralized water. In particular, this method includes the steps of providing a flow of feedwater and purifying and/or demineralized it by a purifying and/or demineralizing process to produce a flow of purified, demineralized water. Carbon dioxide is injected into the purified, demineralized water to provide a flow of carbon dioxide-enriched water. The carbon dioxide-enriched water is then passed through a re-mineralizer which comprises a dolomite medium. This produces a simultaneous remineralization of the water with calcium and magnesium and thus leads to a flow of purified, re-mineralized water.

U.S. Patent Application Publication No. 2020/0055753, published on Feb. 20, 2020 to Minor et al., teaches a water treatment system for treating and distributing water. The system includes a first container and an input conduit that supplies water (both purified and unpurified) to the first container. The system also has a treatment delivery system that delivers a mineral composition into the first container. The system uses a controller to selectively deliver the mineral composition into the first container so that the mineral composition mixes with and dissolves in the water delivered to the first container. This produces treated water having a desired to profile.

European Patent Application No. EP 3 831 468, published on Jun. 9, 2021 to M. Philiburt, discloses a process for providing mineralized drinking water. In particular, this is directed toward providing drinking water from polluted fresh or brackish water.

U.K. Patent Application Serial No. 2590533, published on Jun. 30, 2021 to A. Levy, provides a system and process of mineralizing distilled water with a replenishment of old mineral concentrates solutions. The system comprises a splitter for splitting distilled water into primary and secondary portions. First and second conduits convey the primary and secondary portions, respectively. A column having a mineral matrix is connected to the second conduit to generate a mineralizing concentrate solution. A mixing module is provided for combining a predefined amount of the mineralized concentrate solution with the primary portion of distilled water in order to form a mineralized water mixture. A dispensing module dispenses the mineralized water mixture. A carbonator is connected to the secondary conduit for dissolving carbon dioxide in the secondary portion of the distilled water.

International Publication No. WO 2007/010549, published on Jan. 25, 2007 to M. Gupta, discloses a household reverse osmosis-based drinking water purifier. This purifier has controlled natural mineral content in the purified water. There is a means for subjecting the raw water to reverse osmosis purification to provide treated demineralized water. There is a means for controlled natural mineral incorporation in the demineralized water by purifying the water through OF and/or UV treatment so as to provide for a reverse osmosis-treated and controlled natural mineral content purified water.

International Publication No. WO 2020/127612, published on Jun. 25, 2020 to Wagemanns et al., provides a method and apparatus for producing potable mineralized water. In particular, this method and apparatus uses a cartridge containing a mineral composition. The method includes providing a liquid to be treated to an apparatus for producing the potable mineralized water and adding a carbon dioxide precursor to the liquid. At least a portion of the carbon dioxide precursor is triggered to release carbon dioxide in order to provide carbon dioxide to the liquid. At least parts of the liquid are contacted with a mineral composition such that the mineral composition at least partially dissolves into the liquid in order to provide the potable mineralized water.

International Publication No. WO 2021/234709, published on Nov. 25, 2020 to Makmel et al., discloses a system and method for differential enrichment of water. In particular, this provides for specifically controlled admission of minerals and other nutrients into untreated water or water that has been preliminarily treated in order to selectively remove contaminants therefrom and to provide a desired nutrient profile in the water for use and consumption.

It is an object of the present invention to provide a hose management assembly for a water mineralization system which avoids the tangling and kinking of the hoses extending to or from the housing of the water mineralization system.

It is another object of the present invention to provide a hose management assembly for water mineralization system which avoids the effects of yanking on the hoses during the installation process.

It is another object of the present invention to provide a hose management assembly for water mineralization system that allows each of the hoses to be individually recognized and to avoid any effects of tangling and mis-installation of the hoses.

It is a further object of the present invention to provide a hose management assembly for water mineralization system which is easy to use, easy to install and relatively inexpensive.

These and other objects and advantages of the present invention will become apparent from a reading of the attached specification and appended claims.

### BRIEF SUMMARY OF THE INVENTION

The present invention is a water mineralization system that comprises a housing having a filter positioned therein which the filter as a first hose extending therefrom, a container receptacle assembly affixed to or formed on the housing and adapted to connect with a bottle containing a mineral or a supplement therein, a pump cooperative with the container receptacle assembly so as to pass the mineral or supplement from the bottle into the drinking water prior to the drinking water exiting the housing, a first block affixed to a wall of the housing and adapted to receive a portion of the first hose therein, and a second block affixed to the housing in spaced relation to the first block. The second block is adapted to receive another portion of the first and second hoses therein. The housing has an inlet adapted to allow tap water to pass to the filter by a second hose. The housing has an outlet adapter will allow drinking water to exit the housing by way of the first hose.

In the present invention, the first block has a first channel and a second channel formed therein. The first hose extends through the first channel. The second hose extends through the second channel. The second block has a first channel and a second channel formed therein. The first hose is received in the first channel of the second block. The second hose is received in the second channel of the second block. The first channel of the first block is axially aligned with the first channel of the second block. The second channel of the first block is axially aligned with the second channel of the second block. In the preferred embodiment the present invention, the first channel of the first block is vertically axially aligned with the first channel of the second block. The second channel of the first block is vertically axially aligned with the second channel of the second block. The first hose has a length extending outwardly of the bottom of the first channel of the second block. The second hose has a length extending outwardly of the bottom of the second channel of the second block. The first block is in parallel spaced relation to the second block.

The first channel of the first block has a first locking element affixed thereto. The first locking element is adapted to fix a position of the portion of the first hose in the first channel of the first block. The second channel of the first block has a second locking element affixed thereto. The second locking element is adapted to fix a position of the portion of the second hose in the second channel of the first block. The first channel of the second block has a third locking element affixed thereto or formed thereon. The third locking element is adapted to fix a portion of the another portion of the first hose in the first channel of the second block. The second channel of the second block has a fourth locking element affixed thereto or formed thereon. The fourth locking element is adapted to fix a position of another portion of the second hose in the second channel of the second block.

The housing has a first wall and a second wall opposite to the first wall. The container receptacle assembly is positioned at or adjacent to the first wall. The first and second blocks are affixed to the second wall. The first channel and the second channel of the first block are curved so as to have one end opening to the second wall and an opposite end opening of the bottom of the first block. The first channel and the second channel of the second block are linear so as to have one end opening at the top of the second block and an opposite the end opening of a bottom of the second block.

In the present invention, the filter comprises a reverse osmosis filter. Reverse osmosis filter produces a pure water output and a brine output. The reverse osmosis filter has a third hose connected thereto. The third hose is adapted to remove the brine from the reverse osmosis filter. The first block has a third channel receiving a portion of the third hose therein. The second block has a third channel receiving another portion of the third hose therein.

The pump specifically comprises a first pump cooperative with the container receptacle assembly so as to pass the mineral or supplement from the bottle into the pure water passed by the first hose. The pump further comprises a second pump cooperative with a reverse osmosis filter so as to pass the tap water into and through the reverse osmosis filter so as to produce a pure water output and a brine output therefrom. The brine output passes outwardly of the housing through the third hose. In the preferred embodiment of the present invention, the first pump is a peristaltic pump. The second hose is adapted to connect to a faucet or to a line leading to a faucet such that tap water passes to the filter.

The present invention is also a hose management system comprises a first hose, a second hose, a housing receiving the first hose and the second hose such that the first hose and the second hose extend outwardly of the housing, a first block affixed to the housing and receiving a portion of the first hose therein and a portion of the second hose therein, and a second block affixed to the housing and receiving another portion of the first hose and another portion of the second hose therein. The first and second hoses each have a length extending outwardly of the second block.

In the hose management system of the present invention, the first block has a first channel and a second channel formed therein. The first hose extends to the first channel. The second hose extends the second channel. The second block has a first channel a second channel formed therein. The first hose is received in the first channel of the second block. The second hose is received in the second channel of the second block. The first channel of the first block is axially aligned with the first channel of the second block. The second channel of the first block is axially aligned with the second channel of the second block. The first channel and the second channel of the first block are curved so as to have one end opening to a wall of the housing and an opposite end opening of the bottom of the first block. The first channel and the second channel of second block are linear so as to have one end opening the top of the second block and an opposite end opening at the bottom of the second block.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is an upper perspective view of the water mineralization system of the present invention.

FIG. 2 is a front end view of the water mineralization system of the present invention with the covers removed therefrom.

FIG. 3 is an upper perspective view of the water mineralization system of the present invention showing the interior of the housing and the filtering equipment used within the interior of the housing.

FIG. 4 is an upper perspective view showing the water treatment components associated with the water mineralization system of the present invention.

FIG. 5 is an end view showing the hose management assembly as used in the water mineralization system of the present invention.

FIG. 6 is a side elevational cross-sectional view of the hose management assembly of the water mineralization system of the present invention.

### DETAILED DESCRIPTION OF THE INVENTION

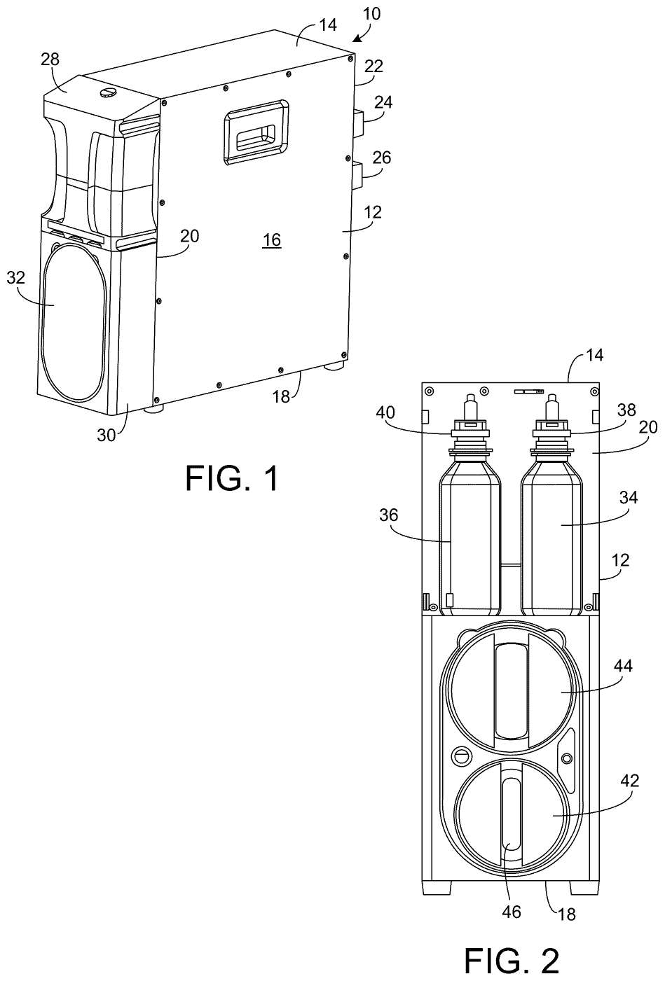

Referring to FIG. 1, there shown the water mineralization system 10 in accordance with the teachings of the present invention. The water mineralization system 10 includes a housing 12 having a generally rectangular cubicle configuration. In particular, housing 12 has upper surface 14, side wall 16, bottom 18, front wall 20 and back wall 22. Walls 14, 16, 18 and 20 enclose the assembly for the treatment of water. In particular, in FIG. 1, the back wall 22 includes a first block 24 and a second block 26 of the hose management assembly of the present invention. The first block 24 and the second block 26 are adapted so as to allow tap water to be introduced into the water mineralization system 10, to allow drinking water to be delivered by the water mineralization system 10, and to allow brine to exit the water mineralization system 10. As will be described hereinafter, the hose management assembly is made up of blocks 24 and 26 which are configured so as to receive separate hoses extending into the interior of the housing 12.

In FIG. 1, it can be seen that there is a first cover 28 that is positioned against the front wall 20 of the housing 12. This first cover 28 extends over the mineral or supplement-containing bottles used in the dosing of minerals into the drinking water. Cover 28 is removably positioned adjacent to the upper surface 14 of the housing 12. A second cover 30 is positioned against the front wall 20 of the housing 12 and extends so as to be positioned generally adjacent to the bottom 18 of the container 12. Second cover 30 is intended to removably cover the filters contained within the housing 12. In particular, second cover 30 can include a flap or surface 32 that can be specifically removed from the cover 30 so as to allow direct access to the filters within the housing 12.

FIG. 2 shows the configuration at the front wall 20 of the housing 12. In FIG. 2, it can be seen that there is a first bottle 34 and a second bottle 36 that are positioned adjacent to the top 14 of housing 12. Each of the bottles 34 and 36 are connected to container receptacle assemblies 38 and 40. The bottles 34 and 36 are removably connected respectively to the container receptacle assemblies 38 and 40. The bottles 34 and 36 can contain minerals and/or supplements therein. In particular, one of the bottles can contain one type of mineral and the other bottle can contain another type of mineral. As such, through a control system, the filtered drinking water can be dosed with a desired quantity of the minerals or supplements from bottle 34 and a desired quantity of the minerals or supplements from bottle 36. If necessary, the control system can be actuated so as to prevent any of the minerals in either of the bottles 34 and 36 from entering the system. The controls can also be adapted to control the rate at which the minerals pass from the bottles 34 and 36 into the filtered water within the interior of the housing 12.

FIG. 2 shows the front wall 20 of the housing 12 with the second cover 30 removed. The removal of the second cover 30 exposes a first filter 42 and a second filter 44. The end of the first filter 42 is exposed at the front wall 20 so that the handle 46 of first filter 42 can be accessed. As such, if it is desired to remove or repair the first filter 42, it is only necessary to remove the cover 30 (or flap 32), access the handle 46, rotate the handle 46 and slide the first filter 42 out of position. A similar action can occur with respect to the second filter 44.

The first filter 42, in the preferred embodiment of the present invention, is a pretreatment filter or a carbon filter. In the preferred embodiment the present invention, the second filter 44 is a reverse osmosis filter. When the first filter 42 is a pretreatment filter, the tap water entering the inlet 24 of the housing 12 will flow in this pretreatment filter so that the pretreatment filter can provide an initial treatment to the water and remove sediment and other contaminants therefrom. The water will flow from the pretreatment filter 42 into the reverse osmosis filter 44 for further removal of any metals, chemicals, contaminants or ions from the water. Importantly, each of the first filter 42 and second filter 44 is located adjacent to the bottom 18 of the housing 12. The first filter 42 and the second filter 44 are also located below the bottles 34 and 36 and located below the container receptacle assemblies 38 and 40. This arrangement greatly improves efficiency in terms of the management of the filters and the bottles. The ease of accessibility of the filters 42 and 44 greatly improves efficiency in the water treatment process and the repair or replacement of the filters.

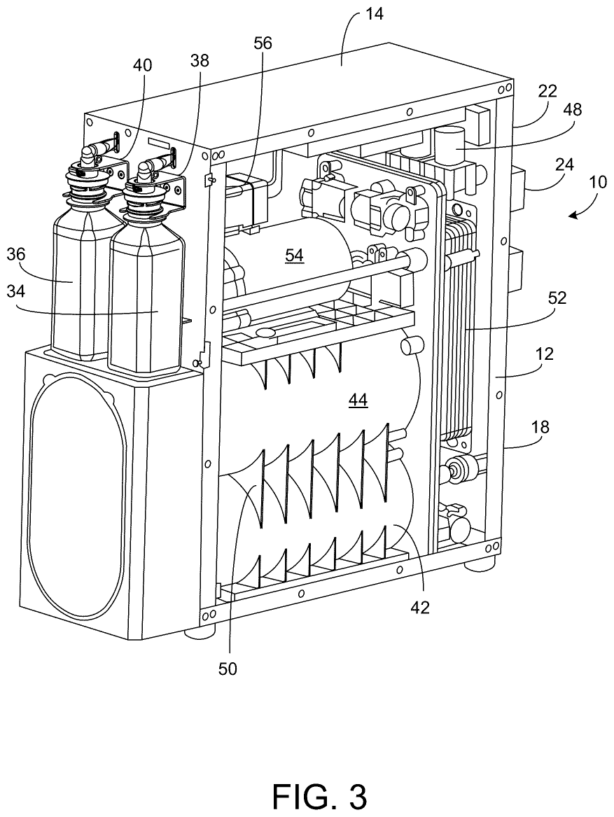

FIG. 3 further shows the water mineralization system 10 of the present invention. In particular, FIG. 3 shows that the block 24 supports a tap water inlet at the back wall 22 of housing 12 and has a valve 48 associated therewith. Valve 48 is movable between an open position and a closed position. In the closed position, tap water flow into the interior of housing 12 is blocked. In the open position, tap water flow into the interior of the housing 12 is permitted. The valve 48 is easily accessible so as to allow water flow to be immediately turned off in the event that leaks should occur or in the event that leak detection equipment within the interior of the housing 12 should signal a leak. The present invention avoids the need to locate the source of the water flow in order to stop the water flow to the water mineralization system 10. The tap water will flow through a hose toward a diaphragm pump 54 and onward to a revers osmosis filter 44 and a sand and/or charcoal filter 42.

In FIG. 3, it can be seen that the first filter 42 and the second filter 44 extend longitudinally across the housing 12. Various brackets 50 support these filters in their desired position. A manifold 52 is illustrated as positioned adjacent to the back wall 18 of the housing 12. Manifold 52 extends in a generally vertical orientation. The manifold 52 is positioned between the first and second filters 42 and 44 and the back wall 18. Manifold 52, as will be explained hereinafter, serves to receive the flow of the mineral or supplement-containing liquid as pumped from the bottles 34 and 36 and mixes this mineral-containing liquid in the manifold 52 with the filtered water from the first and second filters 42 and 44.

Since it is necessary to pressurize the pre-treated water in order to have the pretreatment water flow through the reverse osmosis filter 44, a diaphragm pump 54 is positioned in the interior of housing 12. Diaphragm pump 54 will receive the pretreated water from the first filter 42, pressurize the water, and then pass the water, under pressure, through the second filter 44 (the reverse osmosis filter). The filtrate from the second filter 44 can then flow into the manifold 52 for the purposes of mixing the minerals with the demineralized water.

In the present invention, it is very important to control the rate and amount of the mineral or supplement-containing liquid from the bottles 34 and 36 that enters the filtered water. As such, a peristaltic pump 56 is used in association with each of the bottles 34 and 36. Peristaltic pump 56 operates in a conventional manner so as to assure the delivery of a desired quantity or rate of mineral-containing liquid to the manifold 52. Peristaltic pumps, as they are known, utilize flexible tubes and rollers so as to pass a fixed amount of fluid flow. The peristaltic pump 56 avoids the use of any valves. Suitable servomotors can be utilized in conjunction with the peristaltic pump 56 so as to control the rate at which the mineral-containing liquid is discharged into the manifold 52.

FIG. 3 further shows that the water mineralization system 10 has special container receptacle assemblies 38 and 40 positioned adjacent to the top 14 of housing 12. Peristaltic pump 56 is positioned on the interior of housing 12 and adjacent to these container receptacle assemblies 38. The close positioning of the peristaltic pump 56 to the container receptacle assemblies 38 and 40 assures the proper operation of the peristaltic pump and the proper delivery of fluid from the bottles 34 and 36. If the peristaltic pump 56 were not positioned adjacent to the container receptacle assemblies 38 and 40, there could be more dosing error associated with the delivery of the mineral-containing liquid from the bottles 34 and 36.

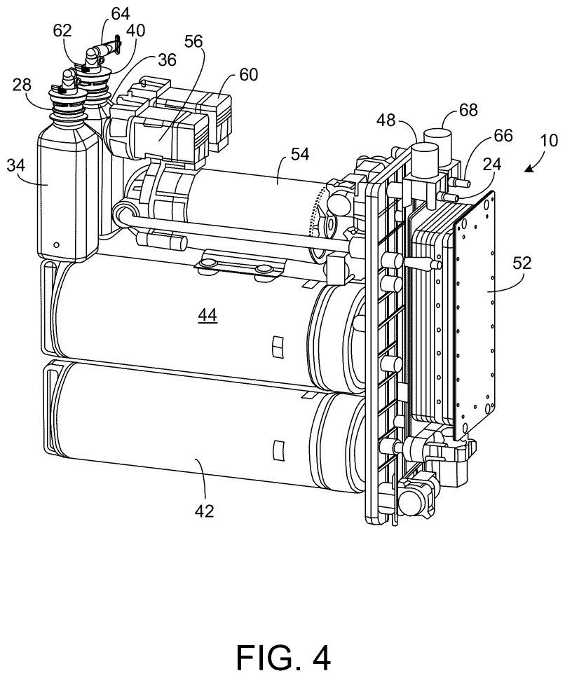

FIG. 4 shows the interior of the water mineralization system 10 of the present invention. In particular, FIG. 4 shows the first filter 42 and the second filter 44 arranged one on top of another adjacent to the bottom of the housing. Bottles 34 and 36 are positioned adjacent to the top of the housing. The peristaltic pump 56 is positioned adjacent to the container receptacle assembly 38. Peristaltic pump 60 is positioned adjacent to the container receptacle assembly 40. A line or conduit will extend from the elbows 62 and 64 of the respective container receptacle assemblies 38 and 40 to the respective peristaltic pumps 56 and 60.

FIG. 4 shows the configuration of the tap water inlet 25 and the outlet 66. Inlet 25 receives the tap water into the interior of the housing. Outlet 66 allows for the discharge of mineralized drinking water from the housing. Valve 48 extends outwardly from the inlet 25 and operates to control the flow of water through the inlet 25. Valve 68 is associated with the outlet 66 and can control the flow of mineralized drinking water out of the outlet 66. Initially, the tap water will flow through the inlet 25 and down to the first filter 42 for pretreatment purposes. The outlet of the first filter 42 will flow to the diaphragm pump 54 for pressurization prior to passing to the second filter 44 (the reverse osmosis filter). Ultimately, the filtered water from the reverse osmosis filter 44 will be devoid of minerals. It can then flow into the manifold 52 for mixing with a mineral-containing liquid from bottles 34 and 36. After mixing, the manifold 52 will then pass the flow of the mineralized drinking water to the outlet 66. The manifold 52 can be connected to the outlet 66 of the housing 12 or it can be the outlet of the housing 12.

It is important to realize that the reverse osmosis filter associated with the second filter 44 will produce a brine. This brine is the result of the filtering of the water in the reverse osmosis filter. Ultimately, the brine will be full of contaminants, particles, and other materials which are entirely removed from the tap water. Ultimately, it is necessary to remove the brine from the water mineralization system 10 of the present invention. As such, an outlet 67 is provided for the discharge of the brine from the reverse osmosis filter.

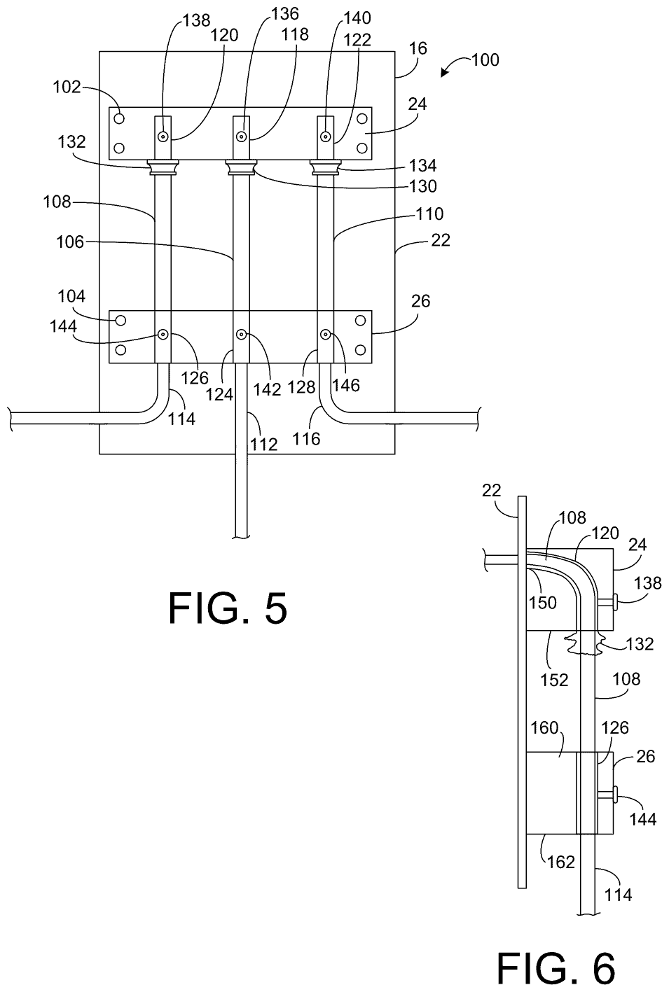

FIG. 5 shows the hose management system 100 of the present invention. The hose management system 100 includes the first block 24 and the second block 26. Blocks 24 and 26 are secured to the wall 22 of the housing 16. In particular, fasteners 102, in the nature of screws and bolts, fasten the first block 24 to the wall 22. Fasteners 104 secure the second block 26 to the wall 22 of housing 16. FIG. 5 shows that the first block 24 receives a portion of the first hose 106 therein, a portion of the second hose 108 therein, and a portion of the third hose 110 therein. The first hose 106 is ultimately connected to the outlet 66 of the water mineralization system 10 so as to deliver product water therefrom. The second hose 108 is connected to the inlet 25 so as to allow tap water to enter the water mineralization system 10 of the present invention. The third hose 110 will be connected to the outlet 67 so as to allow brine to exit the water mineralization system of the present invention.

The second block 26 is affixed to the wall 22 of housing 16 in spaced parallel relation to the first block 24. The second block 26 receives another portion of the first hose 106, the second hose 108 and the third hose 110 therein. Ultimately, the first hose 106 will have a length 112 exiting the second block 26. The second hose 108 will have a length 114 exiting the second block 26. The third hose 110 will have a length 116 exiting the second block 26. The length 112 of the first hose 106 can be connected to a faucet of a sink so that the user can receive mineralized pure water therefrom. The length 114 of the second hose 108 can be connected to a water inlet to the faucet of a sink so as to allow tap water to be introduced into the water mineralization system 10. The length 116 of the third hose 110 can extend to a drain such that the brine resulting from the reverse osmosis treatment of water in the water mineralization system 10 of the present invention can be disposed.

The first block 24 has a first channel 118, a second channel 120 and a third channel 122 formed therein. The first hose 106 extends through the first channel 118. The second hose 108 extends through the second channel 120. The third hose 110 extends through the third channel 122.

The second block 26 has a first channel 124, a second channel 126 and a third channel 128. The first hose 106 will extend to the first channel 124 of the second block 26. The second hose 108 will extend through the second channel 126 of the second block 26. The third hose 110 will extend through the third channel 128 of the second block 26.

FIG. 5 shows that the first channel 118 of the first block 24 is axially vertically aligned with the first channel 124 of the second block 26. Similarly, the second channel 120 of the first block 24 is axially vertically aligned with the second channel 126 of the second block 26. Additionally, the third channel 122 of the first block 24 is axially vertically aligned with the third channel 128 of the second block 26.

In FIG. 5, it can be seen that there is a locking element 130 affixed and cooperative with the first channel 118 of the first block 24. A second blocking element 132 is affixed to or cooperative with the second channel 120 of the first block 24. A third locking element 134 is affixed to and cooperative with a third channel 122 of the first block 24. Locking elements 130, 132 and 132 can be suitably manipulated so as to lock a position of the respective hoses 106, 108 and 110 relative to the first block 24. Additional blocking elements 136, 138 and 140 can also be applied to the respective channels 118, 120 and 122 to additionally fix the position of the respective hoses 106, 108, 110 within the channels. As such, each of the hoses 106, 108 and 108 will be rigidly affixed within the respective channels 118, 120 and 122 of the first block 24.

The channel 124 of the second block 26 has a locking element 142 positioned thereover. Similarly, the channel 126 of the second block 26 has a locking element 144 positioned thereover. The third channel 128 also has a locking element 146 positioned thereover. Locking elements 142, 144, 146 can be in the nature of screw-type fasteners which are designed so as to bear upon an outer surface of the respective hoses 106, 108 and 110 as they pass through the respective channels 124, 126 and 128 of the second block 26.

In the configuration shown in FIG. 5, the hose management assembly 110 is particularly illustrated. Importantly, it is significant to note that this hose management assembly 100 maintains each of the hoses 106, 108 and 110 in spaced parallel relationship to each other. As such, it is easy for an installer to know which of the respective hoses goes to the tap water input, to the pure water output, and to the drain for the brine water. Additionally, the hose management assembly 100 avoids any tangling of the hoses. During transport and installation (without the hose management assembly), hoses could be twisted around each other. It would then become difficult to determine which of the hoses goes to their desired destinations. The use of the blocks 24 and 26 assures that the hoses 106, 108 and 110 do not become tangled. Furthermore, the use of the locking elements of the first block 24 on the respective hoses 106, 108 and 110 avoids any effects of yanking that could serve to disconnect each of the hoses from their respective inlets and outlets within the interior of the housing 16. The locking elements 130, 132 and 134, along with screw-type locking elements 136, 138 and 140, generally fix the position of each of the hoses 106, 108 and 110 within the first block 24. The 90° turn of the hoses is accommodated by the structure of the present invention.

Importantly, the second block 26 is located in a spaced location from the first block 24. This extended positioning of the second block 24 will avoid any kinking that could occur to the hoses 106, 108 and 110 adjacent to the bottom of the first block 24 when the hoses 106, 108 and 110 become extended. It also further creates a retention effect so as to avoid any problems associate with effects yanking on the hoses during the installation of the water mineralization system 10. Locking members 142, 144 and 146 will generally fix the position of each of the hoses 106, 108 and 110 in the second block 26. As such, if a strong pulling force is applied to the extended lengths 112, 114 and 116 of the respective hoses 106, 108 and 110, this yanking force will not extend to the interior of the housing. The hose management assembly 100 effectively and inherently prevents disconnection of the hoses from their required connections within the interior of the housing 16.

FIG. 6 shows the interior configuration of each of the blocks 24 and 26. The hose 108 is particularly illustrated in FIG. 6. In particular, it can be seen that blocks 24 and 26 are affixed to the wall 22 of the housing 16. These can be affixed by the fasteners 102 and 104 (as shown in FIG. 5). The channel 120 of the first block 24 is generally curved so as to allow the second hose 108 to bend when extended therethrough. Ultimately, the channel 120 will open at end 150 at the wall 122. The hose 108 will extend through the channel 120 so as to exit through the bottom 152 of the first block 24. The locking element 132 can be suitably rotated so as to engage with the hose 108 and effectively lock the position of the hose 108 within the interior of the channel 120. A screw-type locking member 138 can be suitably rotated so as to bear against the outer wall of the hose 108 and further fix the position of the hose 108 within the channel 120. As such, the block 24 provides two separate locking elements that can prevent any yanking forces from adversely affecting the connection of the hose 108 with the connectors on the interior of the housing 16.

The second block 26 is illustrated in spaced parallel relation to the first block 24. The second block 26 includes the channel 126 through which the hose 108 extends. In particular, the channel 126 will open at one end at the top surface 160 of the second block 26 and will open at the bottom 162 of the second block 26. The hose 108 extends linearly from the first block 24 to the second block 26 and outwardly through the opening at the bottom 162 of the second block 26. As such, the extended length 114 of the hose 128 will extend outwardly of the second block 26. A screw-type locking member 144 can bear against the outer diameter of the hose 108 so as to lock the hose in position. A similar construction is associated with each of the other channels on the first block 24 and the other channels of the second block 26.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

I claim:

1. A water mineralization system comprising:
a housing having a filter positioned therein, the filter having a first hose extending therefrom, said housing having an inlet adapted to allow tap water to pass to the filter by a second hose, said housing having an outlet adapted to allow drinking water to exit said housing by way of the first hose;
a container receptacle assembly affixed to or formed on said housing, said container receptacle assembly adapted to connect with a bottle containing a mineral or a supplement therein;
a pump cooperative with said container receptacle assembly so as to pass the mineral or supplement from the bottle into the drinking water prior to the drinking water exiting said housing;
a first block affixed to a wall of said housing, said first block adapted to receive a portion of the first and second hoses therein; and
a second block affixed in spaced relation to said first block, said second block adapted to receive another portion of the first and second hoses therein.

2. The water mineralization system of claim 1, wherein said first block has a first channel and a second channel formed therein, the first hose extending through the first channel, the second hose extending through the second channel.

3. The water mineralization system of claim 2, wherein said second block has a first channel and a second channel formed therein, the first hose being received in the first channel of said second block, the second hose being received in the second channel of said second block.

4. The water mineralization system of claim 3, wherein the first channel of said first block is axially aligned with the first channel of said second block, the second channel of said first block being axially aligned with the second channel of said second block.

5. The water mineralization system of claim 4, wherein the first channel of said first block is vertically axially aligned with the first channel of said second block, the second channel of said first block being vertically axially aligned with the second channel of said second block.

6. The water mineralization system of claim 5, wherein the first hose has a length extending outwardly of a bottom of a first channel of said second block, the second hose having a length extending outwardly of a bottom of the second channel.

7. The water mineralization system of claim 1, said first block being in spaced parallel relation to said second block.

8. The water mineralization system of claim 2, wherein the first channel of said first block has a first locking element affixed thereto, the first locking element adapted to fix a position of the portion of the first hose in the first channel of said first block, the second channel of said first block having a second locking element affixed thereto, the second locking element adapted to fix a position a portion of the second hose in the second channel of said first block.

9. The water mineralization system of claim 8, wherein the first channel of said second block has a third locking element affixed thereto or formed thereon, the third locking element adapted to fix a position of the another portion of the first hose in the first channel of said second block, wherein the second channel of said second block has a fourth locking element affixed thereto or formed thereon, the fourth locking element adapted to fix the position of the another portion of the second hose in the second channel of the second block.

10. The water mineralization system of claim 2, the housing having a first wall and a second wall opposite the first wall, wherein the container receptacle assembly is positioned at or adjacent to the first wall, the first and second blocks being affixed to the second wall.

11. The water mineralization system of claim 10, wherein the first channel and the second channel of said first block are curved so as to have one end opening at the second wall and an opposite end opening at the bottom of said first block.

12. The water mineralization system of claim 11, wherein the first channel and the second channel of said second block are linear so as to have one end opening at a top of said second block and opposite end opening at a bottom of said second block.

13. The water mineralization system of claim 2, wherein said filter comprises a reverse osmosis filter that producing a pure water output and a brine output, the reverse osmosis filter having a third hose connected thereto, the third hose adapted to receive the brine output from the reverse osmosis filter, said first block having third channel receiving a portion of the third hose therein, said second block having a third channel receiving another portion of the third hose therein.

14. The water mineralization system of claim 13, said pump comprising:
a first pump cooperative with said container receptacle assembly so as to pass the mineral or supplement from the body into the pure water passed by the first hose; and
a second pump cooperative with said reverse osmosis filter so as to pass the tap water into and through the reverse osmosis filter so as to produce the pure water output and the brine output therefrom, the brine output passing outwardly of said housing through the third hose.

15. The water mineralization system of claim 14, said first pump being a peristaltic pump.

16. The water mineralization system of claim 1, said second hose adapted to connect to a faucet or to a line leading to a faucet such that tap water passes to the filter.

17. A hose management system comprising:
a first hose;
a second hose;
a housing receiving the first hose and the second hose, the first hose and the second hose extending outwardly of said housing;
a first block affixed to said housing, said first block receiving the portion of said first hose therein and a portion of the second hose therein; and
a second block affixed to said housing, said second block receiving another portion of said first hose and another portion of said second hose therein, said first and second hoses each having a length extending outwardly of said second block.

18. The hose management system of claim 17, wherein said first block has a first channel and a second channel formed therein, the first hose extending through the first channel, the second hose extending through the second channel, wherein said second block has a first channel and a second channel formed therein, the first hose being received in the first channel of said second block, the second hose being received in the second channel of said second block.

19. The hose management system of claim 18, wherein the first channel of the first block is axially aligned with the first channel of said second block, the second channel of said first block being axially aligned with the second channel of said second block, said first block being in parallel spaced relation to said second block.

20. The hose management system of claim 18, wherein the first channel and the second channel of said first block are curved so as to have one end opening to the housing and an opposite end opening of the bottom of said first block, the first channel and the second channel of the said second block being linear so as to have one and opening the top of said second block and an opposite end opening of the bottom of said second block.
